(19) United States
(12) Patent Application Publication
(10) Pub. No.: US 2006/0122928 A1
(43) Pub. Date: Jun. 8, 2006

(54) Computerized reverse auction

(76) Inventor: Reginald Henry Gram, Whitby (CA)

Correspondence Address: BIRCH STEWART KOLASCH & BIRCH, PO BOX 747, FALLS CHURCH, VA, 22040-0747, US

(21) Appl. No.: 11/293,193

(22) Filed: Dec. 5, 2005

(30) Foreign Application Priority Data
Dec. 3, 2004 (CA) 2,489,132

(51) Int. Cl. G06Q 40/00

(52) U.S. Cl. 705/37

(57) ABSTRACT

The auction is carried out over the Internet in which the computers of potential bidders are used to access a web server. The server displays on the bidders' computers a description of an article to be auctioned and a table in association with the description. The table sets out consecutive intervals of time which run from a predetermined starting time and terminate at a predetermined later ending time. A price which diminishes in increments from the starting time to the ending time is also set out in the table. The server responds to entry of a bid by correlating the time of entry of the bid to the price associated with the time interval in which the time of entry of the bid occurs. The server records the price associated with the time of entry of the bid and the identity of the bidder. The server can also respond to a forward bid by recording the price bid and determining the time interval associated with the price. On the date in which the time interval occurs, the server records the price bid and the identity of the bidder. The server can also respond to a bid, whether forward or one to take effect immediately, where the amount bid is not shown on the table. Should the seller make the article available for inspection, a tag which displays the table is attached to the article.

### FIELD OF THE INVENTION

This invention relates to a computerized reverse auction and more particularly to a reverse auction in which details of items to be auctioned and the terms and conditions of sale are displayed on a web page and in which prospective bidders access the web page by remote terminals.

### BACKGROUND OF THE INVENTION

A reverse auction occurs when the price of an item to be sold decreases over time and is to be contrasted with a conventional auction when the price increases over time. As time passes at a reverse auction, the price of an item declines whereas at a conventional auction, the price increases. Thus, a delay in bidding in a reverse auction can improve the chances that a potential bidder will pay less for an item whereas a delay at a conventional auction will increase the chances that a bidder will pay more.

Many of the details of a reverse auction are decided by the auctioneer during the course of the auction. Such details as the length of each interval of time during which the asking price remains unchanged and the amount by which the asking price is reduced in successive intervals of time arm generally decided by the auctioneer. His decision will depend on such things as the number of the potential bidders, the wood of the bidders, the time of the day or night that the auction is taking place and so on.

I have invented a method of carrying out a continuous reverse auction over the Internet. Photographs or drawings of items to be auctioned are displayed on a web page which prospective bidders can access by remote terminals. According to my method, the terms and conditions of the auction are determined before the auction begins and not during the course of the auction. The reason for this is that the information necessary for setting the terms and conditions is not available during the auction. For example, there is no way of determining the number of potential bidders, their mood and the time that they are taking to decide whether to make a bid or not.

According to my method, the length of each interval of time during which the asking price of an item to be auctioned remains unchanged is decided beforehand. Also decided beforehand is the amount by which the asking price is to be reduced at the end of each interval of time. This information is displayed in tabular form on the web page so that a potential bidder can see what the asking price is at the time he is looking at the web page and at different times in the future.

By reason of the tabulated information, a bidder can make a bid that is not the asking price at the time that he makes it but is the asking price at some time in the future. Such a bid is referred to as a “forward” bid from this point forward in the description of my method and in the claims.

If the bidder bids an amount that is set out in the table on the screen, he can see when that bid will be accepted assuming of course that the item is still unsold at that time. For example, if the table shows that the asking price for an item on day one is $10.00 and on day three it is $7.00, a bidder can make a forward bid of $7.00 on day one. That bid will be received but not accepted on that day but will be accepted on day three if the item has not already been sold.

A forward bid cannot be made in a live auction where all the participants are physically present at the place of auction or are represented by proxies at that place. It cannot because if such bids were permitted, the result would be chaotic. Bidders and the auctioneer would have to remember the amount of those bids and how long they remained in force. Obviously they would be confused and the auction would be unsatisfactory for all concerned.

### SUMMARY OF THE INVENTION

The method of my invention is carried out over a network in which the computers of potential bidders are used to access a web server. Briefly the method comprises the steps of:

(a) causing the web server to display on the computers an identification of an article to be auctioned for sale and a table in association with the article, the table setting out a plurality of consecutive intervals of time which run from a predetermined starting time and terminate at a later predetermined ending time, the table further setting out a price in association with each the time interval, the price diminishing in increments from the starting time to the ending time;

(b) responding to entry of a bid by one the bidder by correlating the time of entry of the bid to the price associated with the time interval in which the time of entry of the bid occurs; and

(c) recording the price so associated of step (b).

An alternative way in which steps (b) and (c) can be carried out is as follows:

(b) responding to a forward which is made by one bidder by correlating the price so bid to the time interval associated with the price;

(c) tracking the availability of the article for sale prior to the time interval of step (b).

If steps (b) and (c) are carried out in this way then an additional step (d) is added: That step is as follows:

(d) if, on the date in which the tine interval occurs, the article has not previously been sold, recording the price so bid of step (b) as a successful bid.

### DESCRIPTION OF THE DRAWINGS

The method of my invention is described in detail with reference to the accompanying drawings in which:

FIG. 1 is a schematic illustration of sets out the major components necessary to carry out the method of my invention;

FIG. 2 displays what a potential bidder would see on the screen of his monitor;

FIG. 3 displays what a bidder would see on his screen after he has made a bid;

FIG. 4 is a second embodiment of the table illustrated in FIG. 2.

Like reference characteristics refer to like parts or stops throughout the description of the drawings.

### DESCRIPTION OF PREFERRED METHOD

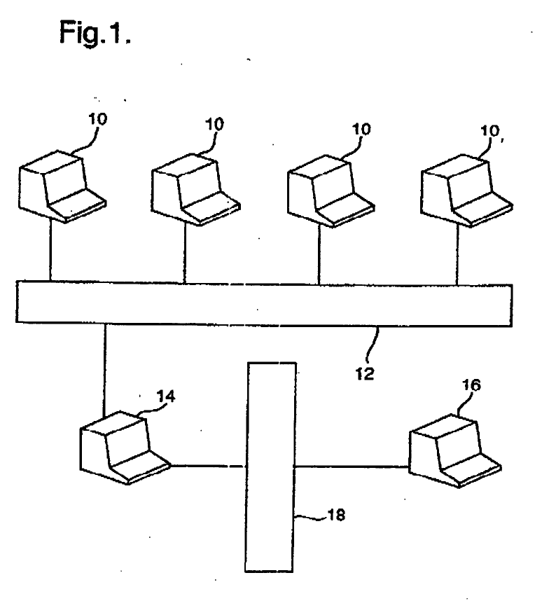

With reference to FIG. 1, a number of computers 10 have access to the Internet 12 and through the Internet to the web server 14 over which the reverse auction of the invention is carried out. Each of the computers 10 has a terminal with the appropriate software for accessing the Internet as has the web server 14. The web server is connected to a supporting server 16 which has the necessary database to carry out the reverse auction. A conventional firewall 18 protects information contained in the supporting server from unauthorized access through the internet.

The database contained in server 16 includes a field for each article to be auctioned including a description of the article, large and small images of the article and information for the table associated with the article. The table and the information that it contains are described below. The field may also include the details of a warranty which applies to the article, the cost of shipping the article to a successful bidder, taxes applicable to the sale, the various methods of bidding on items on the article and so on. The following schedule sets out a sample explanation of how bids can be made.

### Schedule

There are two methods of purchasing items from reverse auction
1. The tag price today
2. Forward Bid: At any time a potential buyer may submit a FORWARD BID to purchase an item or service, should it drop to a specific time-price level. This offer can be submitted personally or by telephone, fax, over the Internet, E-mail or other methods. The bid must be secured by a deposit or by established credit. This deposit will be totally refundable if the item or service is sold before reaching the buyer's selected time-price period. See Seller's payment and removal terms.
NOTE: IF MORE THAN ONE PERSON WISHES TO PURCHASE AN ITEM AT THE SAME PRICE AND AT THE SAME TIME, THE HIGHEST BID (OFFER) WILL BE ACCEPTED, ALL ITEMS HAVE A PRICE TAG ATTACHED.
BOTH METHODS OF PURCHASING ITEMS REQUIRE THAT THE BUYER BE A REGISTERED MEMBER OF THIS WEBSITE. TO JOIN, SIMPLY CLICK HERE AND FOLLOW THE INSTRUCTIONS.
To contact us click here

The web server requires the appropriate software to process a payment for the article. The software has access through the Internet, telephone lines or otherwise to a payment processing firm maintained by banks and other credit granting or approving entities. Payment is usually made by debiting the buyer's account for the cost of the article by means of his credit card, his banking card or other form of card. Such software is well known and in widespread use. The software is not part of the subject invention and is not described herein.

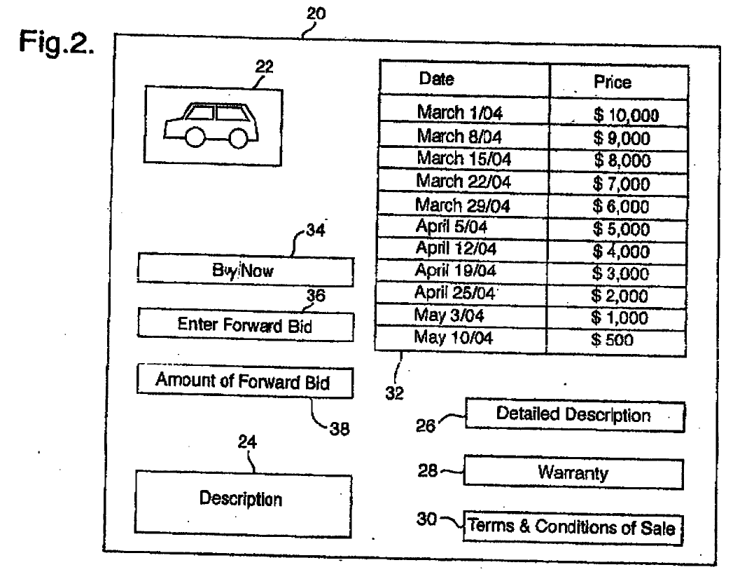

With reference to FIG. 2, the screen 20 of a computer of a potential bidder in the reverse auction of the invention displays a small image 22 of the article to be auctioned and an identifying number and a brief description 24 of the article. Boxes 26, 28 and 30 are labeled “Detailed Description”, “Warranty” and “Terms and Conditions of Sale” respectively and are also displayed on the screen.

When the bidder directs the cursor on his screen onto box 26 and clicks his mouse, a field opens which contains a more detailed description of the article than that set out in box 24. For the sake of brevity in the description that follows, a box is said to be “activated” when the cursor is placed over that box and the mouse is clicked. For example, when box 26 is “activated”, the field which sets out a detailed description of the article is opened.

The description contained in the field opened by activation of box 26 contains not only information such as the model number, serial number, if any, and other information that the buyer will want to know about the article before he submits a bid. The field will also display the location of the article and the times when it is on display should the buyer wish to inspect it before he submits a bid.

When box 28 is activated, a field opens which contains the details of a warranty, if any, which applies to that article and when box 30 is activated a field is opened which sets out the terms and conditions of sale such as how a bid is made, the amount of commission that a buyer will pay, if any, when a sale is completed, the consequences of two bids being received at the same time, the terms and conditions of payment, any disclaimers and so on.

A table 32 also appears on screen 20. The table contains two columns, one entitled “Date” and the other “Price”. All entries in the table are by way of example and to illustrate how the auction is carried out.

The first entry in the Date column is a starting date for the auction which is shown as Mar. 1, 2004 and the final entry in the column is the ending date for the auction which is shown as May 10, 2004. The remaining dates between the starting and final dates are one week apart.

In the column entitled “Price” a price is set out opposite each entry in the “Date” column. Thus the price set out opposite the starting date is “$10,000” and the price set out opposite the ending date is “$500”. The prices diminish by increments of $1,000 from the starting date to the pentultimate date and by $500 between the latter date and the ending date.

The interval of time between the dates in the Date column and the amount by which the price of the article diminishes in the Price column is entirely a matter to be determined between the seller and the operator of the reverse auction. Preferably the time interval is fairly short and the price reduction is substantial so that potential bidders do not lose interest in the auction.

Should the article be on display for an inspection, it is preferable that a tag be attached to it displaying table 32.

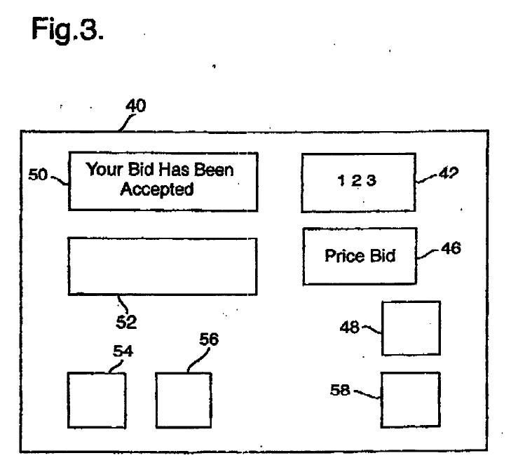

Screen 20 also contains a box 34 entitled “Buy Now” which when activated sends a signal to the web server to indicate that the user of one of the computers which has accessed the web server has entered a bid. Assuming that the bid is entered on. Mar. 8, 2004, the web server will cause a new display to appear on the bidder's screen 40. FIG. 3 shows that screen and is described in detail below.

Screen 20 contains a box 36 entitled “Enter Forward Bid” and a box 38 below that entitled “Amount of Forward Bid”. When a bidder activates box 36, the field in box 38 of his computer opens and the same information as appears in box 32 appears in that field. The bidder can then scroll down to the price which he is prepared to bid for the article. The bidder then clicks on that price and a signal will be sent to the web server to indicate that the user of the computer has entered a forward bid. FIG. 3 will then be displayed on the screen of the bidder's computer.

With reference to FIG. 3, box 42 sets out the identifying number of the article, as set out in box 24 of FIG. 2.

### Immediately Effective Bid

Box 46 sets out the price that has been bid. Should, for example, box 34 have been activated on March 8^{th}, the price that will appear in box 46 will be $9,000. That display indicates that the bid will be accepted provided the bidder can make satisfactory payment of the amount bid together with the buyer's commission, if any, and handling and shipping costs.

Box 48 in FIG. 3 sets out what information the bidder must provide for the web server. He must provide his name, address and how he can be reached. He must also provide the information necessary to determine whether the payment is satisfactory. Such information will usually include such details as the bidder's credit card number and expiry date, banking card number and password and so on. Once that information is provided by the bidder, the web server will communicate with the entity that processes payments in the usual manner to confirm that payment has indeed been made.

Once the processing is complete and payment is made, the field in box 50 will open and the message “Your bid has been accepted” will be displayed. The successful bidder will then be contacted by the method by which the buyer indicates he can be reached and he is informed of his successful bid. Arrangements can then be made at that time should such arrangements not have already been made.

### Forward Bid

Should “Enter Forward Bid” box 36 in FIG. 3 have been activated, the price that the bidder had entered in box 38 will appear in box 46 of FIG. 3. The field in box 52 will then open and indicate that the bid has been recorded and the day on which it will be effective. For example, should a forward bid of $2,000 be entered on March 8^{th}, the message in box 50 will read: “Your bid has been recorded”. The recorded bid will be accepted on April 25^{th} provided that the article has not been previously sold and provided the buyer's is able to make satisfactory payment on that day.

Should the article be one of a kind and it is sold before the date when the reverse bid is effective, the field containing information about the article can simply indicate that the article has been sold. In cases where there is more than one of the same article, it may be advantageous to provide two boxes, 54, 56, the first containing the total number of articles and the second the number yet to be sold. The information set out in these boxes can be useful in creating excitement and encouraging bids when the number yet to be sold approaches zero.

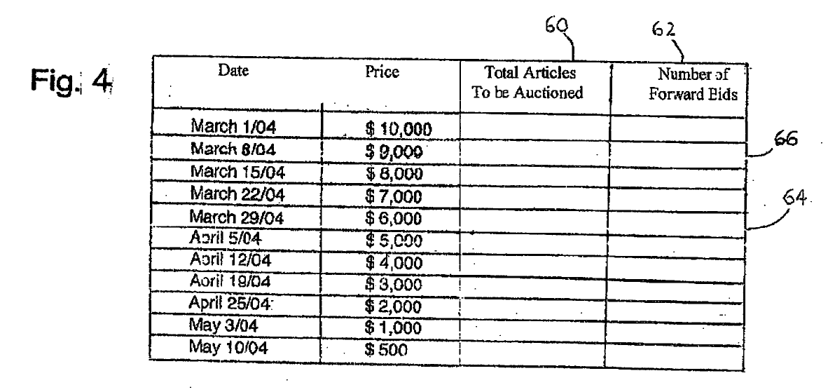

That information set out in boxes 54 and 56 can alternatively be set out in box 32 in two additional columns entitled “Total Articles to be Auctioned” (column 60) and “Number of Forward Bids” (column 62) as illustrated in FIG. 4. A potential buyer can then see how many forward bids have been made and at what price. He can also see how many articles are available to bid on. If, for example, there are four cars on auction and the first forward bid made on Mar. 1, 2004 is for one vehicle at $6,000, the number “1” will appear in both column 60 and 62 in row 64 containing “$6,000”. Should three more forward bids of $6,000 be made, the numbers will be “4” and “4” in row 64. No further forward bids of $6,000 will then be accepted.

Should the next forward bid be for $9,000, the numbers “1” and “1” will appear in columns 60, 62 in the $9,000 row 66 and the numbers in the $6,000 row will reduce to “3” and “3”. One of the buyers in the $6,000 row 64 will be eliminated from the list and the rules of bidding set out in box 30 will determine which one of the three forward bidders will be eliminated.

Once payment has been made, box 58 displays such information as the date of shipment, the name of the shipper and so on.

It will be understood, of course, that modifications can be made in the way in which the reverse auction of the invention is carried out without departing from the scope of the invention as set out in the appended claims.

1. A method of carrying out a reverse-auction over a network in which the computers of potential bidders are used to access a web server, said method comprising the steps of:
(a) causing said web server to display on said computers an identification of an article to be auctioned for sale and a table in association with said article, said table setting out a plurality of consecutive intervals of time which run from a predetermined starting time and terminate at a later predetermined ending time, said table further setting out a price in association with each said time interval, said price diminishing in increments from said starting time to said ending time;
(b) responding to entry of a bid by one said bidder by correlating the time of entry of said bid to the price associated with the time interval in which the time of entry of said bid occurs; and
(c) recording the price so associated of step (b).

2. The method of claim 1 including the steps of:
(d) attaching a tag to said article, said tag displaying said table; and
(e) making said article available for inspection by said potential bidders.

3. The method of claim 1 further including the steps of:
(d) confirming payment of the price so associated of step (c); and
(e) upon confirmation, recording an identification of said one bidder.

4. The method of claim 1 further including the steps of:
(d) recording the number of like articles to be auctioned;
(e) recording the number of successful bids for said articles; and
(f) causing said web server to display on said computers notice that said articles are no longer available to be auctioned in the event that the number of successful bids for said articles of step (d) equals the number of said articles.

5. A method of carrying out a reverse-auction over a network in which the computers of potential bidders are used to access a web server, said method comprising the steps of:
(a) causing said web server to display on said computers an identification of an article to be auctioned for sale and a table in association with said article, said table setting out a plurality of consecutive intervals of time which run from a predetermined starting time and terminate at a later predetermined ending time, said table further setting out a price in association with each said time interval, said price diminishing in increments from said starting time to said ending time;
(b) causing said web server to display on said computers the means by which a potential bidder can enter a bid of any price selected by him for said article;
(c) recording said price of step (b);
(d) causing said web server to display on the computer of said bidder that the bid so selected of step (b) has been accepted in the event that said bid of step (b) is acceptable to a seller of said article.

6. The method of claim 5 including the steps of:
(e) attaching a tag to said article, said tag displaying said table; and
(f) making said article available for inspection by said potential bidders.

7. The method of claim 5 further including the steps of:
(e) confirming payment of the price so associated of step (c); and
(f) upon confirmation, recording an identification of said one bidder.

8. The method of claim 5 further including the steps of:
(e) recording the number of like articles to be auctioned;
(f) recording the number of successful bids for said articles; and
(g) causing said web server to display on said computers notice that said articles are no longer available to be auctioned in the event that the number of successful bids for said articles of step (d) equals the number of said articles.

9. A method of carrying out a reverse-auction over a network in which the computers of potential bidders are used to access a web server, said method comprising the steps of:
(a) causing said web server to display on said computers an identification of an article to be auctioned for sale and a table in association with said article, said table setting out a plurality of consecutive intervals of time which run from a predetermined starting time and terminate at a later predetermined ending time, said table further setting out a price in association with each said time interval, said price diminishing in increments from said starting time to said ending time;
(b) responding to a forward bid which is made by one said bidder by correlating the price so bid to the time interval associated with said price;
(c) tracking the availability of said article for sale prior to the time interval of stop (b); and
(d) if, on the date in which said time interval occurs, said article has not previously been sold, recording the price so bid of step (b) as a successful bid.

10. The method of claim 9 including the steps of:
(e) attaching a tag to said article, said tag displaying said table; and
(f) making said article available for inspection by said potential bidders.

11. The method of claim 9 wherein said web server displays on said computers the number of like articles to be auctioned for sale and the number of forward bids made for said articles at each said price.

12. The method of claim 9 wherein said web server displays on said table the number of like said articles to be auctioned for sale, the number of forward bids made for said articles and the prices so bid.

13. The method of claim 9 further including the steps of:
(e) confirming payment of the price of a successful bid of step (d); and
(f) upon confirmation, recording an identification of said one bidder.

14. The method of claim 9 further including the steps of:
(e) recording the number of like articles to be auctioned;
(f) recording the number of successful bids for said articles; and
(g) causing said web serer to display on said computers notice that said articles are no longer available to be auctioned in the event that the number of successful bids for said articles of step (e) equals the number of said articles.

15. A method of carrying out a reverse-auction over a network in which the computers of potential bidders are used to access a web server, said method comprising the steps of:
(a) causing said web server to display on said computers an identification of an article to be auctioned for sale and a table in association with said article, said table setting out a plurality of consecutive intervals of time which run from a predetermined starting time and terminate at a later predetermined ending time, said table father setting out a price in association with each said time interval, said price diminishing in increments from said starting time to said ending time;
(b) causing said web server to display on staid computers the means by which a potential bidder can enter a forward bid of any price selected by him;
(c) recording said price of step (b);
(d) causing said web server to display on the computer of said bidder of step (e) that the price so selected of step (b) has been accepted in the event that said bid of step (b) is acceptable to a seller of said article.

16. The method of claim 15 including the steps of:
(e) attaching a tag to said article, said tag displaying said table; and
(f) making said article available for inspection by said potential bidders.

17. The method of claim 15 further including the steps of:
(e) confirming payment of the price of a successful bid of step (d), and
(f) upon confirmation, recording an identification of said one bidder.

18. The method of claim 12 further including the steps of:
(e) recording the number of like articles to be auctioned;
(f) recording the number of successful bids for said articles; and
(g) causing said web server to display on said computers notice that said articles are no longer available to be auctioned in the event that the number of successful bids for said articles of step (e) equals the number of said articles.
